(19) United States
(12) Patent Application Publication
(10) Pub. No.: US 2008/0033941 A1
(43) Pub. Date: Feb. 7, 2008

(54) VERFIED NETWORK IDENTITY WITH AUTHENTICATED BIOGRAPHICAL INFORMATION

(76) Inventor: Dale Parrish, Portland, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/462,967

(22) Filed: Aug. 7, 2006

(51) Int. Cl. G06F 17/30

(52) U.S. Cl. 707/6

(57) ABSTRACT

A method of limiting chat room anonymity. The method may include receiving biographical information pertaining to an unverified individual, authenticating that the biographical information is correct for the individual, assigning the individual a verified chat room username that is linked to the authenticated biographical information, and using the authenticated biographical information to selectively limit chat room activity for the username.

### BACKGROUND

The Internet and other distributed networks provide a platform for people to interact using several different forms of communication. For example, some people “chat” by volleying text, audio, and/or video messages back and forth. Emails are one-way communications that allow digital correspondence. Web logs, or blogs, are used to provide commentary, news, or other information to friends and strangers. Online social networks can offer an interactive network of blogs, user profiles, groups, photo albums, and internal chat and email systems that allow people to socialize in a virtual environment. As the Internet continues to mature and become more pervasive, new forms of communication and socialization will continue to develop.

While Internet communication and socialization can be beneficial in many respects, the inventor herein has recognized several issues that can limit desirability for some users. In particular, the nature of the Internet allows people to easily misrepresent aspects of their identity, such as their name, gender, age, location, etc. In one of the most unsavory examples, the Internet allows predators to anonymously communicate with children in ways that are patently inappropriate, and to potentially lure the children into harm's way. In short, anonymity exists on the Internet, and the anonymity can be abused by unscrupulous users.

### BRIEF DESCRIPTION OF THE DRAWINGS

FIG. 1 schematically shows an exemplary computer network with three computer users.

FIG. 2 schematically shows a method for limiting network anonymity.

### WRITTEN DESCRIPTION

The present disclosure is directed to establishing a verified chat room identity to counteract several of the issues that can result from chat room anonymity. In one example, real-world biographical information about a person is collected in a trusted and verifiable manner, and a verified username is issued to the person only after the real-world biographical information is fully assessed and authenticated (or in the case of an existing username, the username is verified only after the real-world information is fully assessed and authenticated). One method of authenticating the real-world biographical information can include performing a background check that includes a criminal record analysis. The verified username can be linked to the authenticated real-world biographical information so that at least selected aspects of the authenticated real-world biographical information can be checked during network communications. In this way, a network user can effectively screen network communications based on selected aspects of the authenticated real-world biographical information, such as age, gender, criminal record, location, or virtually any other attribute.

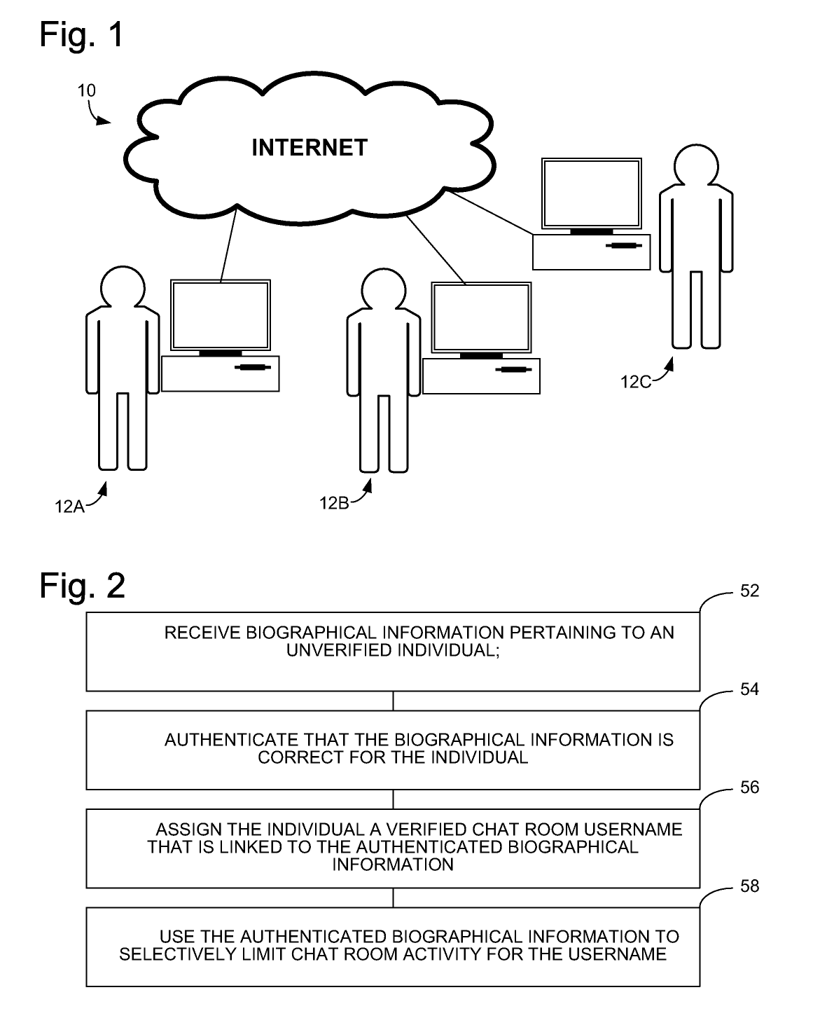

FIG. 1 schematically shows a network 10 of computer users 12a, 12b, and 12c that are communicatively linked via the Internet. When linked, the computer users can communicate with one another via the several different forms of communication that are available on the network. Nonlimiting examples of such forms of communication include chat room communications, emails, blogs, and posts on social networking sites. The Internet is provided as a nonlimiting example of one network that is suitable for communicatively coupling two or more users. Local networks and other private or public extended networks can also communicatively couple two or more users. Similarly, while users 12a, 12b, and 12c are referred to as computer users, it should be understood that users may access a network with any suitable device while remaining within the scope of this disclosure. Such devices can include, but are not limited to, personal computers, laptop computers, personal data assistants, and mobile telephones. While three computer users are illustrated, it should be understood that virtually any number of computer users can communicate via a network.

Many forms of network communications allow a user to use a username, or handle, that serves as a primary source of identification to other users. Many users have two or more usernames that are used with various different network services, and some users have two or more usernames that are used with the same network service (e.g., the same chat room).

Users 12a, 12b, and 12c can communicate with one another without ever actually meeting in person. Many times, the only information one user will have about the identity of another user is that user's username. Sometimes, biographical information can be linked to the username, but this information does not have to be accurate. It is easy for a user to misrepresent even the most basic biographical information. For example, a user can easily lie about his/her name, gender, age, location, or virtually any other biographical attribute. The anonymity of many forms of network communication makes it difficult, if not impossible, to detect such lies.

In an attempt to prevent some forms of network anonymity, attempts have been made to use digital certificates and various forms of cryptography to allow one computer user to verify the network identity of another computer user. However, these techniques do not take any measures to authenticate the biographical information associated with a network identity. In fact, some of these techniques do not require any biographical information to be associated with a network identity. In other words, digital certificates and other forms of cryptographic identification can be used to verify that a communication originates with a particular computer user, but not to authenticate that that computer user has any particular biographical information.

FIG. 2 shows an exemplary method 50 for limiting network anonymity. The method includes, at 52, receiving biographical information pertaining to an unverified individual. Such information can be received directly from a computer user or from a third party. The biographical information can be received via a computer network, or the biographical information can be received through another channel. As mentioned above, the biographical information can include one or more of the following: name, gender, age, grade, residence location, school, employer, physical attributes, criminal record, and others.

At 54, the method includes authenticating that the biographical information is correct for the individual. In this manner, it can be determined if a computer user is actually who they say that they are. A nonlimiting example of authenticating biographical information includes performing a background check. When applying for a username or to have an existing username verified, a computer user can agree to have a background check run, and allow information that is uncovered in the background check to be shared with other network users. Such a background check can include a criminal record check, for example to determine if a user is a sex offender.

In some embodiments, authentication may require a real-world verification of at least one biographical attribute. For example, authentication may include a physical inspection of an official identification card of the username applicant, thus ensuring that the applicant only applies for a username using his own identity. In some embodiments, such inspections may be conducted over the Internet using video conferencing and/or by using other electronic submissions that allow the actual identity of an applicant to be inspected. In some embodiments, authentication may include independent checks by two or more different procedures, or even by two or more different entities.

Identity markers that are difficult to falsify can be used to ensure that a verified username is only used by the owner of the username. As an example, when biographical information is authenticated, biometric samples can be collected, including but not limited to voice samples, facial images, fingerprints, etc. Such samples can subsequently be used to test the identity of a user, thus making it more difficult to hijack a username. As a nonlimiting example, when a user logs in to a network service, such as a chat room, the service can require the user to speak a test phrase. The service may then use voice identification testing to determine if the user logging in is the owner of the username. If the voice does not match the voice of the owner, as previously authenticated, the user can be prevented from logging in. Passwords, digital certificates, and other forms of testing can additionally or alternatively be used.

Furthermore, in some embodiments, repetitive verification of a user's identity may be performed to ensure that the correct individual is continuously using the verified username. For example, this process may be carried out via reoccurring tests of identity markers, such as requesting an individual to speak a randomly generated phrase after a particular period of time has elapsed, which can be used to verify the identity of the user.

Additionally, in some embodiments, verification may be continuously and automatically monitored. For example, use of a verified username may activate a web camera that may stream video screen shots of an individual's face to a monitoring system. The monitoring system may use facial recognition software to verify the user's identity. Such a system further may deny or cut-off access if the individual is not recognized.

At 56, the method includes assigning the individual a verified chat room username that is linked to the authenticated biographical information. As used herein, this includes verifying an existing chat room username. Once biographical information is fully authenticated, and a username is assigned, a level of anonymity can be removed or at least suspended. Individuals who would normally prefer more anonymity as a safety precaution when communicating in a chat room or over a social network may be more inclined to have less anonymity, due to the verification of usernames and biographical information. The level of trust created by the verification of usernames and identities may lead to safe and candid peer to peer communication.

Furthermore, network anonymity can be limited in that a chat room administrator or other network administrator is fully apprised of the authorized biographical information of a user, while that information can be kept at least partially secret from other users on the system. This can be done while still allowing all users to filter for specific biographical attributes, as described below.

At 58, the method includes, using the authenticated biographical information to selectively limit chat room activity for the username. In other words, various filters can be set up at different levels, and such filters can limit network access. For example, network communications can be limited to other users that have a verified username so that the biographical information linked to those users can be trusted. In addition, additional screens may be applied so that communication is limited to users with particular biographical information (or without particular biographical information).

As a first example, a computer user can set up an individual filter that blocks other users that have one or more attributes for which the user is screening. Examples of such screened attributes can include: gender, age, criminal record, etc. By setting up such an individual filter, a user can customize the types of people with which communication occurs.

As another example, a chat host can set up a chat room filter that blocks all users that have one or more attributes for which the room is screened. In this way, the chat room can be kept free of individuals that do not meet the screening criteria.

As yet another example, a parent may use parental monitoring software to restrict a child's network access so as to prevent undesired communication. The parental monitoring software can screen attributes that a parent may feel are inappropriate (e.g., too old, wrong gender, criminal record, etc.).

As another example, a social network service may impose restrictions on users with verified usernames based on biographical information. Namely, the social network service may block interaction between users with different attributes. For example, all users under the age of fifteen may be blocked from communicating with all users over the age of twenty one and vice versa. These and other restrictions can be established on a service-wide basis and/or established only for certain users that are subscribed to such limitations.

The above are nonlimiting examples of the many ways in which biographical information can be used to selectively limit chat room activity. Other selection criteria can be employed without departing from the scope of this disclosure. Such selections can be made by an individual computer user, a service provider, a site operator, or by another entity.

In some embodiments, including each of the above described embodiments, a computer user can continue to meet new people, while avoiding people that do not fit within a predetermined group (e.g., female, under 15 years old). In other words, a computer user need not be limited to chatting with users that are proactively placed on a white list, but can rather chat with anybody that does not violate the selection criteria in effect. In some embodiments, a degree of anonymity can remain. For example, a user's precise age need not be shared even though users with ages outside a selection criteria are blocked. In other words, a 13 year old girl may participate in a chat room that only allows girls that are under 15 years old, and the 13 year old girl need not reveal exactly how old she is. In other embodiments, a user's actual biographical information can be shared with all other users so that no anonymity exists.

A verified network identity, as described above, can be integrated into a network service, such as a chat room hosting service or a social networking service. When implemented in this manner, the network service may require all users to be fully authenticated before a verified username is issued. However, a site may alternatively allow some users to be unverified while other users are verified. In such cases, the verification status of a username can be used as a selection criteria that can be used to determine whether communications are allowed. Furthermore, in some embodiments, users with verified usernames may be granted certain privileges that may not be granted to users with unverified usernames. For example, users with verified usernames may be granted access to secure chat rooms, web pages, and/or may be provided with additional information. Also, users with verified usernames may be afforded use of selected services that users with unverified usernames may not be able to use.

A verified network identity can also be implemented using a third party username verifier that can authenticate biographical information and verify usernames issued from one or more network services. For example, a third party verifier could independently verify usernames from another network service provider, such as MySpace and/or AOL. Such verifications could be used by the network service provider so that communication filtering can be established based on the authenticated biographical information. Even if the network service provider does not itself accommodate filtering based on the authenticated biographical information, a third party service can be used to add this functionality to an existing network service provider.

1. A method of limiting chat room anonymity, comprising:
receiving biographical information pertaining to an unverified individual;
authenticating that the biographical information is correct for the individual;
assigning the individual a verified chat room username that is linked to the authenticated biographical information; and
using the authenticated biographical information to selectively limit chat room activity for the username.

2. The method of claim 1, where authenticating that the biographical information is correct for the individual includes performing a criminal record background check.

3. The method of claim 1, further comprising testing the authenticity of the biographical information before chat room activity.

4. The method of claim 3, where testing the authenticity of the biographical information includes a biometric analysis.

5. The method of claim 4, where the biometric analysis includes voice recognition analysis.

6. The method of claim 4, where testing the authenticity of the biographical information includes using a cryptographic digital signature.

7. A computer readable storage medium having code executable by a computing device to perform a method for limiting chat room anonymity between at least a chat requester and a chat recipient, where at least the chat requester has a verified username linked to authenticated biographical information, and at least the chat recipient has a protection filter configured to block communication based on one or more biographical information parameters, the method comprising:
receiving a chat request from the chat requester to communicate with the chat recipient;
comparing the authenticated biographical information of the chat requester to the protection filter of the chat recipient; and
facilitating communication only if none of the authenticated biographical information of the chat requester violates the protection filter of the chat recipient.

8. The method of claim 7, wherein the protection filter is configurable based on input from the chat recipient.

9. The method of claim 7, wherein facilitating communication includes initiating a chat room session.

10. The method of claim 9, wherein initiating a chat room session includes revealing biographical information to the chat recipient.

11. The method of claim 7, wherein the authenticated biographical information includes at least one of name, gender, age, grade, residence location, school, employer, physical attributes, and criminal record.

12. The method of claim 7, wherein the biographical information is authenticated by at least one third party.

13. The method of claim 7, wherein authentication of biographical information includes a physical inspection of an official identification card.

14. A method of registration and monitoring of users for a social networking service comprising:
receiving biographical information pertaining to an unregistered individual;
authenticating that the biographical information is correct for the individual;
assigning the individual a verified username that is linked to the authenticated biographical information;
providing selected social networking privileges to the individual based on the authenticated biographical information;
detecting an attempted use of the verified username; and
verifying the identity of the individual during the attempted use.

15. The method of claim 14, wherein the social networking privileges include posting content to a webpage.

16. The method of claim 14, wherein the social networking privileges include communicating with other registered users.

17. The method of claim 14, wherein the attempted use of the verified username includes logging onto a network server.

18. The method of claim 14, wherein the biographical information includes at least one of name, gender, age, grade, residence location, school, employer, physical attributes, and criminal record.

19. The method of claim 14, further comprising creating a protection filter associated with the verified username configured to block communication with other registered users based on selected biographical information parameters.

20. The method of claim 19, wherein the selected biographical information includes at least one of an age difference and an age threshold.
